(19) United States
(12) Patent Application Publication
(10) Pub. No.: US 2011/0302096 A1
(43) Pub. Date: Dec. 8, 2011

(54) AUTHENTICATION SERVICE FOR SALES OF GOODS AND SERVICES

(75) Inventor: T. Ethan Lowry, Santa Clara, CA (US)

(73) Assignee: APPLE INC., Cupertino, CA (US)

(21) Appl. No.: 12/792,622

(22) Filed: Jun. 2, 2010

(51) Int. Cl. G06Q 99/00; G06Q 50/00; G06Q 30/00

(52) U.S. Cl. 705/318; 705/27.1

(57) ABSTRACT

An authentication service provides authentication information to help potential buyers determine the legitimacy of an offer to sell a good or service. For example, an authentication service stores registration information that indicates (a) that a particular item was purchased by a particular party, and (b) contact information that indicates a particular address for communicating with the party. When the registered owner of an item wants to sell the item, the owner sends an intent-to-sell message to the authentication service. In response to receiving the intent-to-sell message, the authentication service sends access information to the particular address. The access information specifies a manner of receiving authentication information about the item from the authentication service. The registered owner includes the access information in his or her advertisements for the item. When a potential buyer sees the access information in an advertisement, the potential buyer can obtain the authentication information, directly from the authentication service, using the manner specified in the access information.

### FIELD OF THE INVENTION

The present invention relates to authentication systems and, more specifically, to systems and techniques for authenticating that an offered good or service is legitimate.

### BACKGROUND

There have always been forums for selling used goods. Traditionally, such forums have included flea markets, garage sales, classified advertisements, swap meets, etc. Due to modern technology, the number of forums for selling used goods has increased significantly. Such forums now include online auction sites, online classified ads, etc.

Unfortunately, such forums have always been and continue to be the habitat of swindlers. All too often a potential buyer belatedly discovers that something about the sale was not legitimate. Typical problems include, among other things: the seller disappears without delivering anything, the delivered goods are not what was advertised, and the goods are stolen goods.

Various mechanisms have been developed for allowing sellers to establish their legitimacy. For example, many online sites allow customers to rate and leave comments about the sellers with whom they have transacted. In addition, various certification entities have been established. A seller may complete the certification process with such entities, and thereafter advertise that they are certified by the entities.

Unfortunately, none of the mechanisms for establishing the legitimacy of a sale work well for low-volume sellers. For example, if a person that has not previously sold anything on an online site simply wants to sell their used computer on the site, they will not have any ratings or comments by which potential buyers can judge them. Likewise, the effort involved in becoming certified by a certification entity is not justified in these situations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates communications that occur between an authentication service and other entities, according to an embodiment;

FIG. 2 is a block diagram that illustrates communications that occur between an authentication service and a communication-capable item, according to an embodiment;

FIG. 3 is a block diagram illustrating authentication information that may be provided by an authentication service, according to an embodiment; and

FIG. 4 is a block diagram of a computer system upon which the techniques described herein may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system is provided to allow sellers of goods or services to establish their legitimacy without going through a lengthy certification process. In one embodiment, an authentication service stores registration information that indicates (a) that a particular item was purchased by a particular party, and (b) contact information that indicates a particular address for communicating with the party. The authentication service may be controlled by the store from which the item was originally purchased, controlled by the manufacturer of the item, or may be a separate third-party authentication service. The address may be any type of address to which private information may be communicated, such as a mailing address, a telephone number, an instant message identifier, a fax number or an email address.

In one embodiment, when the registered owner of an item wants to sell the item, the owner sends an intent-to-sell message to the authentication service to indicate a desire to sell the particular item. In response to receiving the intent-to-sell message, the authentication service sends access information to the particular address. Because the access information is sent to the address that is in the authentication service's records, rather than to the address from which intent-to-sell message originated, only the registered owner of the item should receive the access information.

In one embodiment, the access information specifies a manner for third parties to obtain authentication information from the authentication service. The authentication information provided by the authentication service may include at least a portion of the registration information for the item. For example, the access information may comprise a hyperlink which, when activated, retrieves a page, from the authentication service, that contains a description of the item and some of the contact information for the registered owner of the item.

If the intent-to-sell message was not from the registered owner, then receiving the access information from the authentication service will alert the registered owner that someone is perpetrating a fraud. On the other hand, if the intent-to-sell message was from the registered owner, then the registered owner may include the access information in his or her advertisements for the item.

When a potential buyer sees the access information in an advertisement, the potential buyer can obtain the authentication information, directly from the authentication service, using the manner specified in the access information. By comparing the authentication information against the information that the potential buyer knows about the seller, the potential buyer can determine the legitimacy of the seller. For example, if the authentication information indicates a different owner than the seller, then the potential buyer may determine that the sale is not legitimate. Further, in the case where the authentication information indicates the address (mail, email, phone, etc.) of the legitimate owner, the potential buyer may attempt to contact the seller using that address. If the potential buyer is not able to contact the seller through the address specified in the authentication information, then the potential buyer may decide that the seller is not the legitimate owner.

### Registering Purchase Information

As mentioned above, in one embodiment, legitimate owners are able to register purchase information with an authentication service. The information that is provided to the authentication service during the registration process is referred to herein as registration information.

In one embodiment, the authentication service may be the manufacturer or the retailer of the item, and the registration process is either performed at the point of sale by the retailer, or performed by the purchaser subsequent to the sale. The registration process may involve any of a variety of communication mechanisms, such as mail, email and/or fax. The specific communication mechanism used to communicate the registration information to the authentication service may vary from implementation to implementation. In some embodiments, the authentication service may support several different types of mechanisms for users to communicate registration information to the authentication service.

In an alternative embodiment, the authentication service is neither the manufacturer nor the retailer, but a third party service. In the case of a third party service, the authentication service may be designed to receive the registration information directly from the manufacture, directly from the retailer, and/or directly from the buyer. According to one embodiment, for authentication services that allow multiple types of entities (manufacturers, retailers, and buyers) to submit registration information, the actual source of the information is stored as part of the registration information. Thus, when subsequent potential buyers see the registration information, the potential buyers may place more confidence in registration information that was received by the authentication service from a manufacturer, than in registration information that was received by the authentication service directly from an alleged purchaser.

### Registration Information Content

Registration information that is provided to the authentication service may include several types of information. For example, for items that have serial numbers, the registration information may include the serial number of the item. Many other types of item identification information may be included, instead of or in addition to serial numbers. For example, the item identification information may include a photograph of the item, a written description of the item, the technical specification of the item, etc.

In addition to item identification information, the registration information may include purchaser identification information. The purchaser identification information may include an address (phone number, email address, mailing address, instant messaging user-id) of the purchaser. In addition, the purchaser identification may include a photograph of the purchaser, a description of the purchaser, a web site address associated with the purchaser, etc.

Beyond the item identification information and the purchaser identification information, the registration information maintained by the authentication service may include additional details that a future potential buyer of the item would consider relevant. For example, the registration information may include the date of purchase, the date the item was registered with the manufacturer, and the date at which the item was registered with the authentication service (if different from the manufacturer). Date information may be particularly useful in identifying fraud. For example, fraud is more likely when the registration information indicates that the item was purchased three years ago, but registered with the authentication service yesterday, than if the registration also took place three years ago.

### Intent-to-Sell Messages

When a user that has registered his/her purchase of an item with the authentication service desires to sell the item, the user sends an intent-to-sell message to the authentication service. Any form of communication mechanism may be used to communicate the intent-to-sell message to the authentication service. For example, the user may send a letter to the authentication service, send an email to the authentication service, specify an intent to sell using controls provided by a web page from a web site controlled by the authentication service, call the authentication service by phone, etc.

The communication mechanism by which the intent-to-sell is communicated by the purchaser may be entirely different from the communication mechanism by which the registration information was originally sent to the authentication service, both of which may be different from the communication mechanism associated with the address that was provided by the owner in the registration information. For example, the registration may have been performed automatically over a network by the retailer at the time of purchase, the address registered for the purchaser may be a instant messaging user-id, and the intent-to-sell message may be a phone call from the registered owner to the authentication service.

### Access Information

In response to receiving an intent-to-sell message for a particular item, the authentication service sends access information that indicates how potential buyers can obtain, from the authentication service, authentication information about the item. As shall be described in greater detail hereafter, the authentication information is information that will assist potential buyers to determine the legitimacy of an offer. The authentication information may include, for example, some or all of the registration information.

According to one embodiment, the authentication service sends the access information to the address identified in the purchase information, regardless of the means by which the intent-to-sell message was received. Thus, even if the intent-to-sell message took the form of an email, the authentication service would send the access information by mail if the registered address is a mailing address, by fax if the registered address is a fax number, or by phone if the registered address is a phone number. Sending the access information to the address that was specified when the original purchase was registered increases the likelihood that the registered owner will be the only person that receives the access information.

The access information indicates how potential buyers can obtain authentication information for the item from the authentication service. The nature of the access information may vary based on the manner that the authentication service is able to provide the authentication information. For example, if the authentication service is designed to provide the authentication information over the Web, then the access information may be a hyperlink which, when activated, causes a web server controlled by the authentication service to send a web page that contains the authentication information. Alternatively, if the authentication service is designed to provide authentication information by email, the access information may identify the specific email address to which an email request must be sent to obtain the authentication information for the item.

In one embodiment, the access information may include a key or password that is required to obtain authentication information about the item from the authentication service. For example, the access information may indicate that authentication information is obtained by sending an email to xxx@yyy.com, with the key “xyxyxy” in the subject line of the email. Alternatively, the access information may indicate that the user is to log onto yyy.com, and enter the password “xyxyxy” when prompted by that web page. As yet another example, the access information may indicate that the user it to call a particular phone number, and ask about item 1234567.

### Authentication Information

Authentication information refers to the information that is provided by the authentication service when someone uses requests the authentication information in the manner specified in the access information. The authentication information may include some or all of the item identification information from the registration information, some or all of the purchaser identification information from the registration information, and any number of additional pieces of information.

For example, in one embodiment, the authentication information includes the serial number of the item, photos of the item, data that identifies the date that the item was registered, data that indicates the entity that performed the registration, data that identifies the date on which the photos were uploaded, the original purchaser's address, and the date on which intent-to-sell messages were received for the item.

In one embodiment, the registered owner is able to specify, through controls on web pages provided by the authentication service, the type of information that is to be included in the authentication information. For example, some registered owners may be comfortable with allowing potential buyers to see their real name and email address. Other sellers may be comfortable with only allowing potential buyers to see their email address. Yet other sellers may opt for the authentication service to provide a proxy email address that masks the seller's real address but will cause email to be forwarded to the seller's real address. When potential buyers send email to the proxy address provided in the authentication information for an item, the authentication service receives and forwards the email message to the actual email address that was registered by the owner.

### Advertising with Access Information

Once the registered owner receives the access information, the registered owner may incorporate the access information into the owner's offers to sell the item. For example, in the case where the access information is a hyperlink, the owner may include the hyperlink in the advertisements that the owner places online. For offline advertisements, such as classified ads in physical newspapers, a URL may be printed in the ad to allow a potential buyer to manually enter the URL into a browser to obtain the authentication information.

In one embodiment, online reselling forums, such as online classified ads or auction sites, may have explicit support for interacting with the authentication service. For example, when a user is posting an item for an online auction, an auction site may provide the user with controls through which users may enter a key that was provided by the authentication service in response to an intent-to-sell message. When the seller enters such a key using the controls provided by the auction site, the auction site adds a special control to the item's auction page. For example, the auction site may add an “authentication information button” to the item's auction page. When the special control is activated, the auction site retrieves the authentication information from the authentication service, and displays the authentication information to the user that selected the control.

The authentication information allows potential buyers the ability to better determine the legitimacy of the sale. For example, a fraudulent sale may be indicated by authentication information that (a) does not indicate recent receipt of an intent-to-sell message, (b) has product information that does not match the product information provided in the advertisement, (c) does not have an address through which the seller can be contacted, etc.

### Example Process

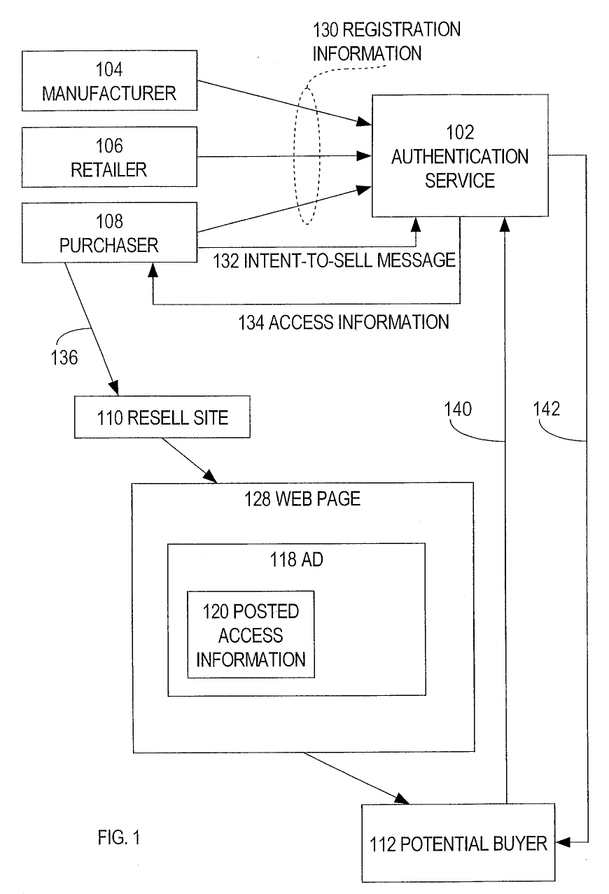

Referring to FIG. 1, it is a block diagram that illustrates the various parties and messages involved in an authenticated re-sale of an item. Initially, the item is registered by sending registration information 130 to the authentication service 102. The party that sends the registration information 130 may be the manufacturer 104 involved in the initial sale, the retailer 106 involved in the initial sale, and/or the original purchaser 108. These parties are merely examples of the entity that may be involved in the original registration of an item. Further, the authentication service 102 may be provided by the manufacturer 104 or retailer 106.

As mentioned above, the registration information 130 may include many pieces of information. In one embodiment, the registration information 130 includes information about the item, information about the purchaser 108, and an address for contacting the purchaser 108.

When the original purchaser 108 decides to sell the item, the original purchaser 108 sends an intent-to-sell message 132 to the authentication service 102. The intent-to-sell message 132 may take many forms, including mail, email, etc. According to one embodiment, the authentication service 102 is an online service, and the intent-to-sell message 132 is communicated by activating a control on a web page that is provided by the authentication service 102.

In response to receiving the intent-to-sell message 132, the authentication service 102 sends access information 134 to the address that was identified in the registration information 130. The original purchaser 108 is then able to post the access information 134 on resell forums. For example, in the embodiment illustrated in FIG. 1, the original purchaser 108 sends a message 136 to cause the item to be advertised in an ad 118 of resell site 110. Resell site 110 may be, for example, an online classified advertisement site.

A potential buyer 112 may see the posted access information 120 on the ad 118 on the resell site 110 by retrieving from the resell site 110 a web page 138 that contains the ad 118. The potential buyer 112 may then use the access information to send a request 140 for authentication information 142 from the authentication service 102. In response to the request 140, the authentication service 102 sends authentication information 142 relating to the item.

### Communication-Capable Items

Some items, such as computers, cell phones, and personal digital assistants, may provide the functionality through which the items themselves may be registered or authenticated. For example, upon buying a particular computer, the buyer may use the computer to contact the authentication service to perform the initial registration. Under these circumstances, the authentication service may provide an additional safeguard to verify that the device performing a subsequent transaction is in fact that device that was registered.

For example, many computer devices have unique identifiers built in to their hardware. The MAC addresses employed by many electronic devices are examples of such identifiers. According to one embodiment, the unique identifier associated with a device is automatically extracted from the device at the time of registration, and sent to the authentication service to be stored along with the rest of the registration information.

Subsequently, when the owner wants to sell the device, the unique identifier is automatically extracted from the device again and sent to the authentication service along with the intent-to-sell message. If the unique identifier that is included in the intent-to-sell message matches the unique identifier that was stored with the registration information, then it is highly likely that the intent-to-sell message was sent by someone who actually possesses the registered device.

In embodiments where unique identifiers are extracted from the hardware as part of the authentication process, the authentication service may provide the program(s) used to perform the extraction. For example, in one embodiment, a user registers a computing device by downloading from the authentication service to the computing device a plug-in registration client. The plug-in registration client extracts the unique identifier from the hardware, and prompts the user for the purchaser identification information. The authentication service then saves the unique identifier along with the rest of the registration information for the device. Similarly, a user may indicate an intent to sell by downloading from the authentication service a plug-in “sell item” client. The sell item client would extract the unique identifier from the device, and send to the authentication service an intent-to-sell message that includes the unique identifier.

According to one embodiment, the unique identifier associated with a communication-capable item is not embedded in the hardware of the item. Instead, the unique identifier is provided to the purchaser in some other way. For example, the unique identifier may be specified in a file contained in the storage of the item, may be sent to the purchaser via email, may be communicated to the user at the time of purchase, or may simply be the serial number printed on the communication-capable device. When the unique identifier is maintained as electronic data, the electronic data that contains the unique identifier may be encrypted using a private key, as shall be described in greater detail hereafter.

### Communication-Capable Item Example

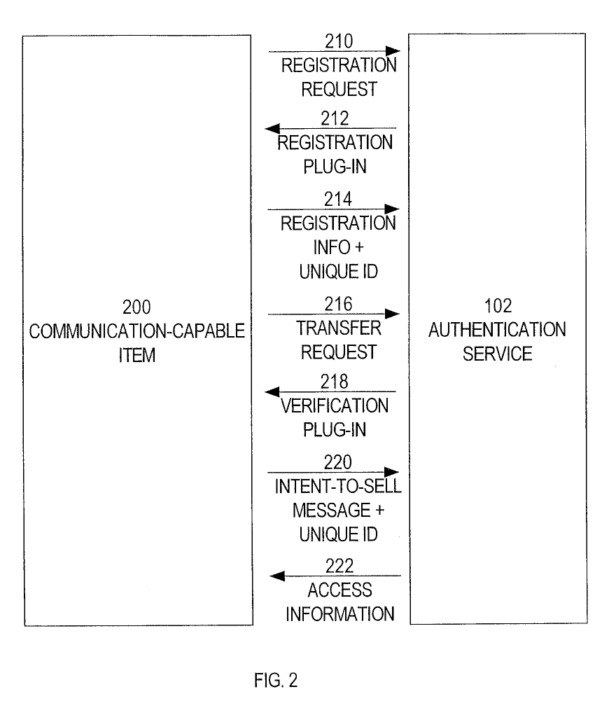

Referring to FIG. 2, it is a block diagram that illustrates the various communications that may take place between a communication-capable item 200 and the authentication service 102, according to an embodiment of the invention.

As illustrated in FIG. 2, the communication-capable item 200 sends a registration request 210 to the authentication service 102. In response, the authentication service 102 sends a registration program 212 to the communication-capable item. In the case where the communication-capable item 200 is a computing device, the registration program 212 may be a plug-in. The communication-capable item 200 executes the registration program, causing the registration program to gather registration information. The registration program 212 may, for example, generate a user interface through which the user may enter purchaser information. In addition, the registration plug-in reads a unique identifier from the hardware of the communication-capable item. The unique identifier is transmitted in a message 214 back to the authentication service 102 along with the registration information.

When the purchaser wants to sell the communication-capable item 200, the user causes the communication-capable item 200 to send a transfer request 216 to the authentication service 102. In response to the request, the authentication service 102 sends a verification plug-in 218 to the communication-capable item 200. The verification plug-in extracts the unique identifier from the hardware of the communication-capable item 200 and sends the unique identifier with an intent-to-sell message 220 to the authentication service 102. The authentication service 102 compares the unique identifier provided by the verification plug-in to the unique identifier that is stored with the registration information to determine whether the two values match. If the two values match, then the authentication service 102 provides the access information 222 to the communication-capable item 200.

Rather than residing in hardware, the unique identifier may be encoded in data that has been encrypted based on a private key. Under these circumstances, the verification plug-in 218 may request that the user enter the public key required to decrypt the unique identifier. The authentication service may have sent the public key to the user previously using the address that was registered by the user at the time of purchase. In response to the user entering the public key, the verification plug-in 218 decodes the unique identifier.

The interactions illustrated in FIG. 2 are merely one way in which a communication-capable item 200 may interact with an authentication service 102. For example, rather than perform the unique identifier comparison at the authentication service 102, the verification plug-in may be encoded with the registered unique identifier before the verification plug-in is sent to the communication-capable item. Consequently, the verification plug-in can perform the comparison at the communication-capable item, and only send back an intent-to-sell message if the two values match.

In one embodiment, if the item is a communication-capable item 200, then the registration information need not include an address for contacting the purchaser. Instead, once the verification plug-in verifies that the item on which the verification plug-in is running is the registered item, the verification plug-in would itself display or otherwise provide the access information.

### Certificates of Ownership

According to one embodiment, certificate of ownerships are used in conjunction with the authentication service. A certificate of ownership is any information that is provided to the purchaser that allows the purchaser to show that the purchaser purchased the item. In one embodiment, the authentication service only allows users that possess certificates of ownership to register items and/or submit intent-to-sell messages for those items. In an alternative embodiment, users that do not have certificates of ownership may still use the authentication service, but the authentication information that is provided to potential buyers indicates whether the alleged owner provided a certificate of ownership for the item to the authentication service.

In one embodiment, key-pair encryption is used to implement a certificate scheme. For example, assume that the item is a computing device. The computing device may initially be encrypted by the manufacturer using a private key. As a result of the encryption, some or all of the functionality of the computing device is unavailable (e.g. the computing device may not boot up). A corresponding public key may be required to unlock the computing device.

The public key may be provided to the user in a variety of ways. For example, to ensure that only the registered purchaser is able to unlock the computing device, the vendor may send the public key to the address provided by the registered purchaser. Alternatively, the public key may be provided to the purchaser on a USB drive, or any other data transfer mechanism. In one embodiment, the purchaser is asked to provide a password during the registration process. The public key is then generated based on the password. The authentication service provides a mechanism, such as a web site, through which the purchaser is able to retrieve the public key in response to providing the correct password.

Once the user obtains the public key, the public key is used to unlock the functionality of the device. According to one embodiment, the program that unlocks the functionality of the device upon receiving the public key also sends a message to the authentication service to indicate that the device has been unlocked. The date on which the device was unlocked in this manner may be included in the authentication information that is provided by the authentication service to potential buyers.

When the original purchaser subsequently desires to sell the device, the public key that was provided to the purchaser may be treated as the user's certificate of ownership. The authentication service may be configured to honor only intent-to-sell messages that are accompanied by the correct public keys. Alternatively, the authentication service may honor intent-to-sell messages that are not accompanied by public keys, but the authentication information provided would indicate whether the intent-to-sell messages were accompanied by the correct public keys.

### Authentication History

According to one embodiment, the authentication service may support multiple forms of interactions with the registered owner of an item. For example, in one embodiment, the authentication service may be configured to periodically poll the registered owner through the address provided during registration. For example, if the address is an email address, then the authentication service may periodically send email messages to the address. Such polling messages may simply test whether the email address is still good, or may request a response from the owner. For example, the email messages may request that the owner activate a certain link to verify that the owner still owns the registered item. As another example, the authentication service may periodically prompt registered owners to upload current photos of their registered items.

Instead of or in addition to polling the owner, the authentication service may provide a mechanism for the owner to proactively indicate that the owner still owns the item. For example, the user may be able to log in to a web site provided by the authentication service, and mark those registered items that the owner still owns. For registered items that the user no longer has, the user may indicate a status such as “thrown away”, “given away”, “sold”, “lost” or “stolen”.

The authentication service stores data that identifies such post-registration interactions, as well as the dates on which the interactions took place. This information may be included in the authentication information that is provided to potential buyers that request the authentication information in the manner specified in the access information. This post-registration information may be particularly useful in identifying fraudulent sales. For example, if the post-registration information indicates that the registered owner sold the item, then the advertised offer is probably a fraud. On the other hand, if the user has uploaded new photos of the item during each polling interval since the initial purchase, then the advertised offer is probably legitimate (assuming that the potential buyer is able to communicate with the seller using the registered address).

### Authentication Testing

According to one embodiment, the authentication history of communication-capable items may list the dates on which the communication-capable item passed “authentication tests”. An authentication test is generally any test of whether the registered owner is in possession of the registered item. For example, at any time while the registered owner owns a communication-capable item, the registered owner may download and execute an identification-checker program from the authentication service. The identification-checker program performs a test to verify that the item on which the program is running is the same item that was registered. For example, the identification-checker program may extract the unique identifier from the hardware of the item and send the item identifier to the authentication service to be compared to the unique identifier that was stored in during registration. If the communication-capable item passes the test, then the authentication service stores data indicating that the date on which the authentication test was passed.

The history of authentication tests, and the results of those tests, may be included in the authentication information that is provided to potential buyers. Based on the authentication testing history, potential buyers can have some degree of confidence that the communication-capable item was actually in possession of the registered owner at least as of the date that the communication-capable item most recently passed an authentication test.

### Authentication Page Example

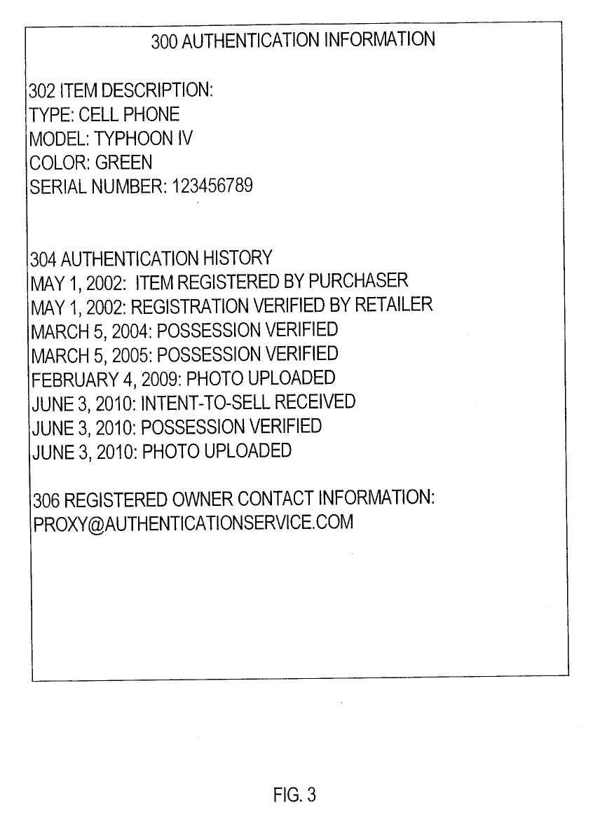

Referring to FIG. 3, it is a block diagram illustrating authentication information 300 that may be provided by the authentication service to a potential buyer, according to an embodiment of the invention. The authentication information 300 may be provided in the form of a web page, an email, a text message, an instant message, etc. In the illustrated embodiment, the authentication information 300 includes an item description section 302, an authentication history section 304 and contact information 306.

The item description section 302 includes information about the particular item for which the authentication information is being provided. In the illustrated example, the item is a cell phone, and the item description section 302 identifies the type, model, color and serial number of the item. These are merely examples of the types of information that the authentication service may provide for an item.

The authentication history section 304 includes the history of authentication-related events relating to the item. In the present example, the authentication history section 304 indicates when the item was registered by the purchaser, and that the retailer verified the registration with the authentication service. The authentication history section 304 also indicates that possession of the cell phone was verified on various dates, and that photos were uploaded. On Jun. 3, 2010, the authentication service received an intent-to-sell message from the registered owner. On that same day, the owner uploaded a photo, and verified possession of the item.

The contact information 306 indicates the means by which the potential buyer can contact the registered owner of the item. In the present example, the contact information is a proxy email address provided by the authentication service. The authentication service maintains a mapping between the proxy addresses and the actual registered addresses of registered owners. When email is sent to a proxy address provided by the authentication service, the authentication service forwards the email on to the corresponding registered email address.

### Secure Identifiers

Certain types of unique identifiers may be “spoofed”. If a communication-capable item has a spoofable unique identifier, then someone may be able to pass an authentication test for an item without actually possessing the item. In one embodiment, to prevent inaccurate authentication test results, communication-capable items are equipped with hardware in which the unique identifiers are private-key encrypted. Further, the authentication service, which has the public key needed to unencrypt the unique identifier, does not provide the public key to the purchaser. Instead, programs provided by the authentication service unencrypt the unique identifier as needed to perform authentication.

For example, at the time of registration, registration software provided by the authentication service may decrypt the unique identifier and store the unique identifier with the registration information. Subsequently, a program from the authentication service may use the public key to decrypt the unique identifier as part of an authentication test. A program from the authentication service may also decrypt and extract the unique identifier in response to an intent-to-sell message, to verify that the intent-to-sell message originated from a party that currently possesses the communication-capable item.

### Transfer of Registration

Communication-capable items may also be used to transfer the registration from the registered owner to a subsequent purchaser. In one embodiment, a seller downloads a plug-in “transfer” client. The transfer client extracts the unique identifier from the device, and compares the unique identifier with the unique identifier stored with the registration information. If the unique identifiers do not match, then the transfer client generates an error message and aborts the transfer operation. The transfer client may also communicate back to the authentication service that the unique identifiers did not match, thereby informing the authentication service that someone may be attempting to perpetrate a fraud.

If the unique identifiers do match, then the transfer client receives information about the new owner, including an address that will be used by the authentication service to communicate with the new owner. In response to receiving user input that the sale is final, the registration information maintained for the item by the authentication service is updated to reflect the purchaser information of the new owner, and the date on which ownership was transferred.

In addition to causing the registration information to be updated, the transfer client may provide an option for the device to be “wiped” upon the finalization of the sale. When the wipe option is selected, completion of the sale causes the device to execute instructions that delete information from storage associated with the device. The wipe may be complete, or may simply revert the device to the state in which it existed at the time of the original sale.

In one embodiment, the authentication service performs transfers by concurrently establishing secure connections with both the seller and the buyer. The seller submits a first part of a password known to the authentication service, and the buyer submits a second part of the password. In response to receiving both parts of the password through secure communications, the authentication service updates the registration information to reflect the transfer of the item to the buyer.

In embodiments where the unique identifier of the item is initially encrypted using a first private key, transfer of the item may involve (a) decrypting the unique identifier using a first public key that was provided to the original purchaser, and (b) re-encrypting the unique identifier using a second private key that is different from the first private key. A second public key associated with the second private key is provided by the authentication service to the new owner, but not to the seller. Because the unique identifier would be encrypted based on the new private key, the seller would no longer be able to use the first public key to extract the unique identifier. Because the seller would not be able to extract the unique identifier, the seller would no longer be able to use the authentication service for sales or transfers of the item.

### Authentication-Service-Initiated Posts

In the examples given above, it was assumed that a seller of an item would post advertisements for the item, and that those advertisements would convey the access information that will allow potential buyers to obtain the authentication information from the authentication service. In an alternate embodiment, the authentication service itself may post advertisements on one or more reselling sites.

Specifically, in response to receiving an intent-to-sell message for an item, the authentication service tests to see if the message was from the registered owner. Such a test may involve, for example:
checking for a match between the registered identifier of the item and the unique identifier extracted from a communication-capable item,
obtaining the correct password or public key from the user that submitted the intent-to-sell message, or
sending a link to the registered email address, and detecting that the link was activated.

If the authentication service determines that the intent-to-sell message is from the registered owner of the item, then the authentication service may itself post advertisements for the item on reseller sites. The service-placed advertisements may contain authentication information, including the address of the registered owner. Under these circumstances, the access information that is sent by the authentication service to the registered owner may simply be links to the advertisements that were placed by the authentication service.

### Reseller-Initiated Authentication

According to one embodiment, reseller sites may communicate directly with the authentication service to verify that offers that are posted on their sites are legitimate. For example, a user may send an intent-to-sell message to the authentication service. The authentication service verifies that the intent-to-sell message is from the registered owner using one of the various techniques described herein. The user would then post an advertisement to sell the item on a particular reseller site, and indicate to the reseller site that the offer is for a “safe sale”.

In response to the indication that the offer is for a safe sale, the reseller site sends a message to the authentication service requesting that the authentication service verify that the offer is legitimate. In response to an indication from the authentication service that the offer is legitimate, the reseller site may treat the advertisement differently than other advertisements. For example, the reseller site may provide a “safe sale indicator” on the advertisement. As another example, the reseller site may list the offer ahead of offers that have not been authenticated.

For increased security, the authentication service checks not only whether an intent-to-sell message has been received on the item, but also verifies that the user that is posting the offer on the reseller site is the registered owner. The authentication service may perform this verification in a variety of ways. For example, the authentication service may send a key to the registered address in response to the intent-to-sell message.

In response to a user requesting that an advertisement be authenticated, the reseller site may request that the user provide the key. The reseller site then sends the user-provided key to the authentication service along with the request for authentication. If the key received by the authentication service with the authentication request matches the key that was provided by the authentication service to the registered user, then the authentication service communicates to the reseller service that the offer is legitimate.

### Authentication Prerequisites

According to one embodiment, the authentication service does not provide authentication information for all items that have been registered with the authentication service. Specifically, the authentication service may impose certain prerequisites which, if not satisfied, will prevent the authentication service from providing authentication information regardless of whether the registered user otherwise satisfies the requirements of the system.

For example, in one embodiment, the authentication service does not provide access information to the registered owner of an item if the item has not been registered with the authentication service for a minimum period of time (e.g. three months). During those three months, the authentication service may allow third parties to perform searches against the serial number of the registered item, thereby allowing the third parties to catch attempts by others to register stolen items. If the authentication service receives an intent-to-sell message before the minimum period of time has expired, then rather than send the access information, the authentication service responds with a message that indicates that the minimum period has not yet lapsed.

As another example, if the most recent verification test has failed, or the last successful verification is too stale, then the authentication service may refuse to provide access information for obtaining the authentication information. Under these circumstances, the authentication service may prompt the registered owner to download a verification program, or perform some other act that verifies possession of the item.

As yet another example, the authentication service may cease to provide authentication information for an item if too much time has lapsed from receipt of the intent-to-sell message. For example, if the most recent intent-to-sell message for an item is more than three months old, then the authentication service may cease providing authentication information for the item, until a new intent-to-sell message is received.

### Items without Unique Identifiers

Some items are not marked with unique identifiers. For example, pieces of furniture often do not have serial numbers. For such items, other types of item identification information may be registered with the authentication service. For example, during the registration process, the authentication service may ask the user if the item has a unique identifier, such as a serial number. If the user indicates that the item does not have a unique identifier, then the authentication service may request that the user upload a photo of the item as part of the registration process. Photos are merely one example of the type of information that may be used during the registration process to identify an item that does not have a unique identifier.

### Authentication of Services

The authentication service may be used to establish the legitimacy of services, as well as offers to sell items. For example, a person may register information about their business with the authentication service. Subsequent to registration, third parties that transact with the business may indicate to the authentication service that those transactions occurred.

Under these circumstances, the item description section of the authentication information may be a general description of the services that are provided by the person, and the authentication history section may be a list of the dates and parties that have engaged in transactions with that person. In advertisements for those services, the person may place access information which, when used by third parties, causes the authentication service to provide the authentication information for that business.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

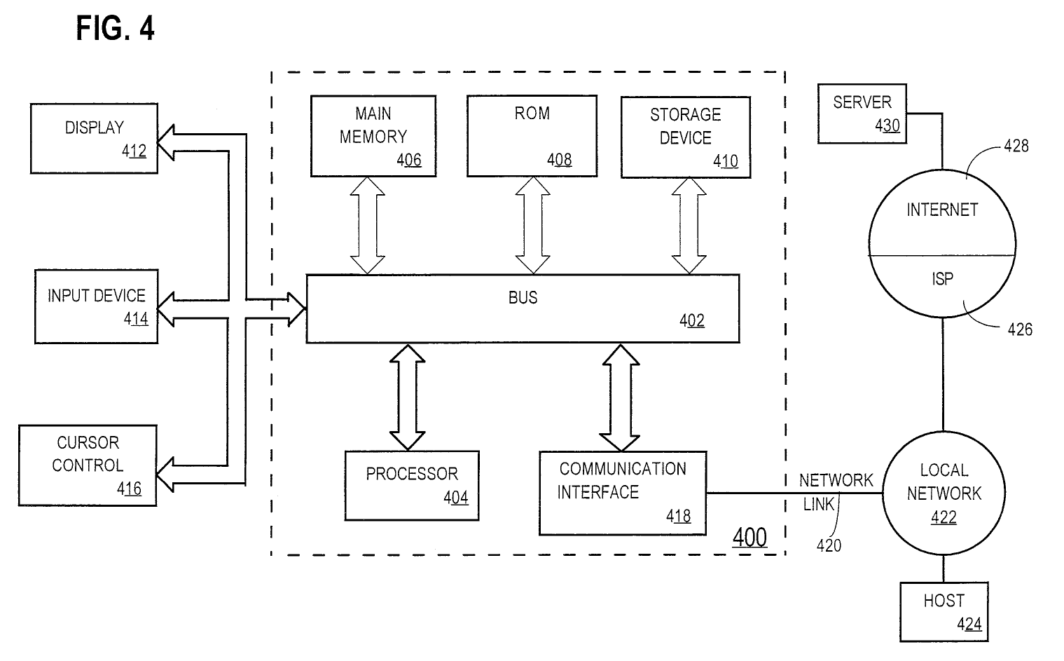

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense.

What is claimed is:

1. A method comprising:
an authentication service storing registration information that indicates:
that a particular item was purchased by a first party; and
contact information that indicates a particular address for communicating with the first party;
the authentication service receiving an intent-to-sell message that indicates a desire to sell the particular item;
in response to receiving the intent-to-sell message, the authentication service sending access information to the particular address;
wherein the access information specifies a manner for potential buyers to obtain authentication information from the authentication service, wherein the authentication information includes at least a portion of the registration information for said particular item;
the authentication service providing the authentication information to potential buyers that employ the manner identified in the access information;
wherein the method is performed by one or more computing devices.

2. The method of claim 1 wherein the particular address is one of an email address, a mailing address, or a telephone number.

3. The method of claim 1 further comprising:
storing timing data that indicates when the intent-to-sell message was received; and
wherein the authentication information that is provided to potential buyers includes the timing data.

4. The method of claim 1 wherein the access information includes a link which, when activated by potential buyers, causes retrieval, from the authentication service, of a web page that contains said authentication information.

5. The method of claim 1 wherein the authentication information includes the particular address.

6. The method of claim 1 wherein the authentication information includes a proxy address for the particular address.

7. The method of claim 1 wherein the authentication information includes a history of at least one interaction between the authentication service and the first party subsequent to an initial registration of the particular item.

8. The method of claim 7 wherein the at least one interaction was initiated by the authentication service.

9. The method of claim 7 wherein the at least one interaction was initiated by the first party.

10. The method of claim 7 wherein:
the particular item is a communication-capable item; and
the at least one interaction includes a test to determine whether the first party is still in possession of the communication-capable item.

11. The method of claim 10 wherein the test involves executing a program on the communication-capable item to extract a first unique identifier from the communication-capable item, and comparing the first unique identifier with a second unique identifier that was stored as part of the registration information.

12. A method comprising:
storing, at an authentication service, a first identifier for an item;
comparing the first identifier to a second identifier extracted from the item by an identifier-checker program executing on the communication-capable item;
at the authentication service, storing a record of when the second identifier was extracted from the item and whether the second identifier matched the first identifier;
in response to a request, the authentication service reading the record and sending authentication information about the item, wherein the authentication information indicates when the second identifier was extracted from the item and whether the second identifier matched the first identifier.

13. A non-transitory storage storing instructions which, when executed by one or more processors, cause:
an authentication service storing registration information that indicates:
that a particular item was purchased by a first party; and
contact information that indicates a particular address for communicating with the first party;
the authentication service receiving an intent-to-sell message that indicates a desire to sell the particular item;
in response to receiving the intent-to-sell message, the authentication service sending access information to the particular address;
wherein the access information specifies a manner for potential buyers to obtain authentication information from the authentication service, wherein the authentication information includes at least a portion of the registration information for said particular item;
the authentication service providing the authentication information to potential buyers that employ the manner identified in the access information;
wherein the non-transitory storage is performed by one or more computing devices.

14. The non-transitory storage of claim 13 wherein the instructions include instructions for:
storing timing data that indicates when the intent-to-sell message was received; and
wherein the authentication information that is provided to potential buyers includes the timing data.

15. The non-transitory storage of claim 13 wherein the access information includes a link which, when activated by potential buyers, causes retrieval, from the authentication service, of a web page that contains said authentication information.

16. The non-transitory storage of claim 13 wherein the authentication information includes the particular address.

17. The non-transitory storage of claim 13 wherein the authentication information includes a history of at least one interaction between the authentication service and the first party subsequent to an initial registration of the particular item.

18. The non-transitory storage of claim 17 wherein:
the particular item is a communication-capable item; and
the at least one interaction includes a test to determine whether the first party is still in possession of the communication-capable item.

19. The non-transitory storage of claim 18 wherein the test involves executing a program on the communication-capable item to extract a first unique identifier from the communication-capable item, and comparing the first unique identifier with a second unique identifier that was stored as part of the registration information.

20. A non-transitory storage storing instructions which, when executed by one or more processors, cause:
storing, at an authentication service, a first identifier for an item;
comparing the first identifier to a second identifier extracted from the item by an identifier-checker program executing on the communication-capable item;
at the authentication service, storing a record of when the second identifier was extracted from the item and whether the second identifier matched the first identifier;
in response to a request, the authentication service reading the record and sending authentication information about the item, wherein the authentication information indicates when the second identifier was extracted from the item and whether the second identifier matched the first identifier.
